(19) United States
(12) Patent Application Publication
(10) Pub. No.: US 2020/0114495 A1
(43) Pub. Date: Apr. 16, 2020

(54) Quick Release Ratchet Tool

(71) Applicant: Easy Tool Enterprise Co., Ltd., Taichung City (TW)

(72) Inventor: Jheng-Tsung Jiang, Taichung City (TW)

(21) Appl. No.: 16/594,326

(22) Filed: Oct. 7, 2019

(30) Foreign Application Priority Data
Oct. 16, 2018 (TW) 107213935

(51) Int. Cl. B25B 15/04; B25B 23/00

(52) U.S. Cl. CPC B25B 15/04; B25B 23/0035

(57) ABSTRACT

A ratchet tool includes an insert engaged in a handle, and a shaft rotatably engaged through the insert, the shaft includes a non-circular hole for engaging with a tool bit, and a number of teeth formed on the shaft, a detent is engaged in the shaft and engageable with the tool bit, the insert includes a head having two or more pawls for engaging with the teeth of the shaft and for determining a driving direction of the shaft by the insert, a sleeve is rotatably engaged onto the shaft and engageable with the detent for forcing the detent to engage with the tool bit, and a control ferrule is engaged onto the shaft and the sleeve for moving the sleeve relative to the shaft.

### TECHNICAL FIELD

This invention relates to a ratchet tool, such as a ratchet screwdriver, and it specifically relates to a ratchet screwdriver including a reduced structure or configuration for allowing the ratchet screwdriver to be easily and quickly and readily actuated or operated by the users or the like.

### BACKGROUND

Typical ratchet tools, such as ratchet screwdrivers comprise a ratchet device or ratchet mechanism attached or mounted or secured to a screwdriver handle for controlling or operating the screws or fasteners in different operation direction.

For example, U.S. Pat. No. 5,535,648 to Braun et al., U.S. Pat. No. 5,749,271 to Liu, U.S. Pat. No. 5,749,272 to Phan, U.S. Pat. No. 5,752,590 to Lin, U.S. Pat. No. 5,806,381 to Lin, U.S. Pat. No. 5,910,196 to Huang, U.S. Pat. No. 5,913,596 to Lin, and U.S. Pat. No. 5,974,915 to Chou disclose several of the typical ratchet devices or ratchet tools or ratchet screwdrivers each also comprising a screwdriver handle, a driving shaft or shank attached or mounted or secured to the screwdriver handle, and a ratchet device or ratchet mechanism attached or mounted or secured to the handle and engaged with the driving shaft for controlling or determining the driving or operating direction of the driving shaft with or by the screwdriver handle or the like.

However, the ratchet device or ratchet mechanism may be disposed or located outside the handle and may greatly increase the volume or the standard of the ratchet tools.

Therefore, how to solve the problems and drawbacks of the prior art have become topics of great concerns of the related suppliers.

The present invention has arisen to mitigate and/or obviate the afore-described disadvantages of the conventional ratchet tools.

### SUMMARY OF THE INVENTION

The main objective of the present invention is to provide a ratchet tool or ratchet screwdriver including a reduced structure or configuration for allowing the ratchet screwdriver to be easily and quickly and readily actuated or operated by the users or the like.

In accordance with one aspect of the invention, there is provided a ratchet tool comprising a handle including a chamber formed in the handle, an insert received and engaged in the handle and rotated in concert with the handle, a shaft rotatably engaged through the insert, the shaft including a non-circular hole formed in the shaft for receiving and engaging with a tool bit and for allowing the tool bit to be rotated and driven by the shaft, the shaft including an aperture formed in the shaft and communicating with the hole of the shaft, the shaft including a number of teeth formed on an outer peripheral portion of the shaft, a detent received and engaged in the aperture of the shaft and engageable into the hole of the shaft for engaging with the tool bit, the insert including a head having a first pawl and a second pawl for engaging with the teeth of the shaft and for determining a driving direction of the shaft by the insert, a sleeve rotatably engaged onto the shaft and engageable with the detent for forcing the detent to engage with the tool bit selectively, and the sleeve including an inner peripheral groove formed in the sleeve for receiving and engaging with the detent and for allowing the detent to be engaged into the peripheral groove of the sleeve and for allowing the tool bit to be disengaged from the shaft, a spring biasing member engaged onto the shaft and engaged with the sleeve for biasing and forcing the sleeve to move relative to the shaft and to separate the peripheral groove of the sleeve from the detent, and a control ferrule rotatably engaged onto the shaft and the sleeve and engaged with the sleeve and for forcing the sleeve to move relative to the shaft and for aligning the peripheral groove of the sleeve with the detent. The insert and the follower are received and engaged in the handle such that the ratchet tool includes a reduced structure or configuration for allowing the ratchet tool to be easily and quickly actuated or operated by the users.

The control ferrule includes a peripheral flange engaged with the sleeve and for engaging with the sleeve and for forcing the sleeve to move relative to the shaft. The insert includes at least one notch formed in the head for forming the first pawl and the second pawl in the head and for engaging with the teeth of the shaft.

A follower may further be provided and rotatably engaged onto the shaft, the follower includes a space formed therein for engaging with the shaft and for allowing the follower to be rotatably engaged onto the shaft. The follower includes a first recess and a second recess formed in the follower and directed toward the head of the insert, and the insert includes a spring biased projection engaged in the head and directed toward the follower for engaging with either the first or the second recess of the follower.

The follower includes a non-circular outer peripheral portion formed thereon, the control ferrule includes a non-circular space formed in the control ferrule for slidably receiving and engaging with the non-circular outer peripheral portion of the follower and for allowing the follower to be rotated relative to the shaft and the insert with the control ferrule.

Further objectives and advantages of the present invention will become apparent from a careful reading of the detailed description provided hereinbelow, with appropriate reference to the accompanying drawings.

A detailed description is given in the following embodiments with reference to the accompanying drawings.

### BRIEF DESCRIPTION OF THE DRAWINGS

The components, characteristics and advantages of the present invention may be understood by the detailed descriptions of the preferred embodiments outlined in the specification and the drawings attached. Embodiments of the invention are illustrated by way of example, and not by way of limitation, in the figures of the accompanying drawings in which like reference numerals refer to similar elements.

FIG. 1 is a partial perspective view of a ratchet tool or ratchet screwdriver in accordance with the present invention;

FIG. 2 is a partial cross sectional view of the ratchet tool, taken along lines 2-2 of FIG. 1;

FIG. 3 is a cross sectional view of the ratchet tool, taken along lines 3-3 of FIG. 2;

FIG. 4 is a partial exploded view of the ratchet tool, as seen from the front portion of the ratchet tool; and

FIG. 5 is another partial exploded view of the ratchet tool, as seen from the rear portion of the ratchet tool.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

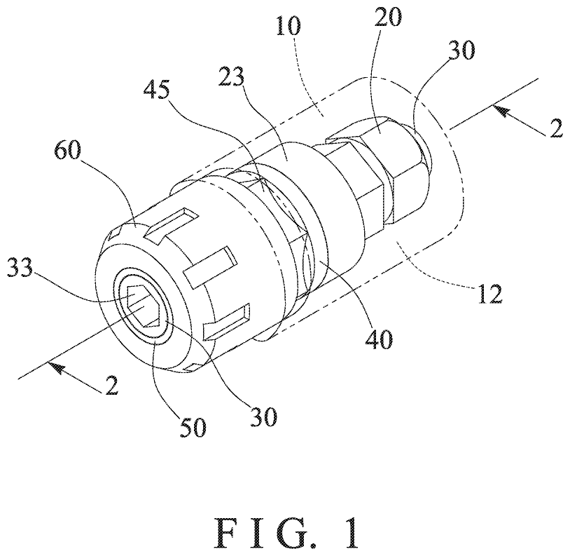

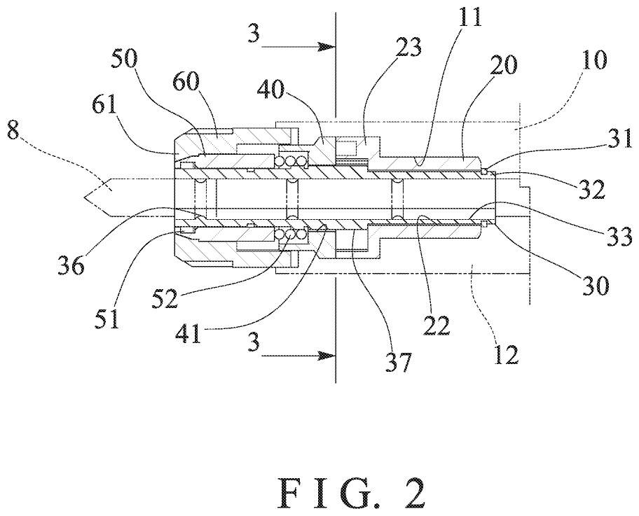

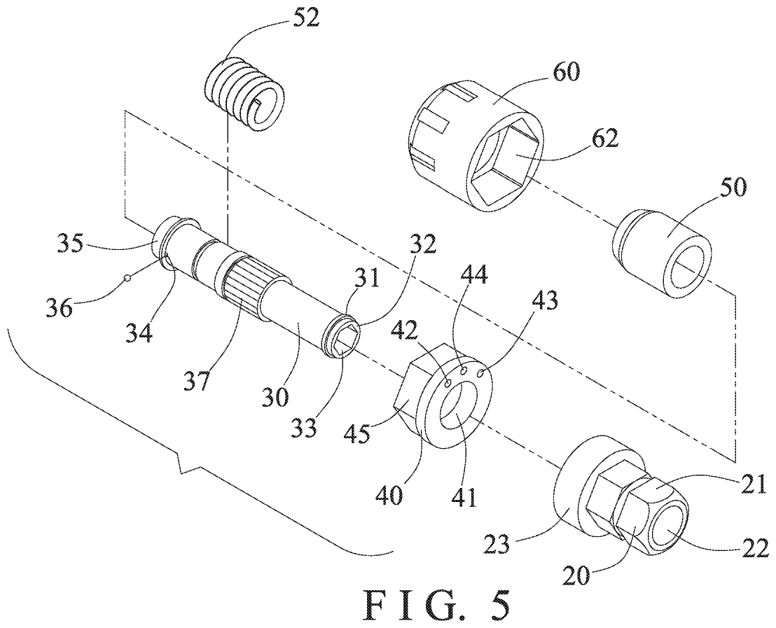

Please referring to the drawings, and initially to FIGS. 1 and 2, a ratchet tool in accordance with the present invention comprises a screwdriver handle 10 including a compartment or chamber 11 formed therein, such as formed in the front portion 12 thereof, and the screwdriver handle 10 may be made of relatively softer materials, such as plastic, rubber, synthetic materials or the like, and a driving block or base seater or insert 20 is received or engaged in the handle 10, such as engaged in the front portion 12 of the handle 10, and includes a non-circular outer peripheral portion 21 formed or provided thereon for engaging with the handle 10 and for allowing the insert 20 to be pivoted or rotated in concert with each other. The insert 20 includes a bore 22 formed therein (FIGS. 2, 5).

As shown in FIGS. 1-2 and 4-5, a driving shank or shaft 30 is pivotally or rotatably engaged into or through the bore 22 of the insert 20, and a clamping or retaining ring 31 is attached or mounted or secured to the shaft 30, such as attached to the inner end portion 32 of the shaft 30, and contacted or engaged with the insert 20 for rotatably anchoring or retaining or positioning the shaft 30 to the insert 20 and for preventing the shaft 30 from being disengaged or separated from the insert 20. The shaft 30 further includes an elongated or longitudinal bore or hole 33 formed therein and having a non-circular cross section, such as a hexagonal cross section, for receiving or engaging with a tool bit 8 (FIG. 2) and for allowing the tool bit 8 to be pivoted or rotated or driven by the shaft 30, and the shaft 30 further includes an aperture 34 formed therein and formed through the shaft 30 and communicating with the hole 33 of the shaft 30 for receiving or engaging with a detent 36 therein. The shaft 30 may further include a number of teeth 37, such as ratchet teeth 37 formed or provided thereon, such as formed on the outer peripheral portion of the shaft 30.

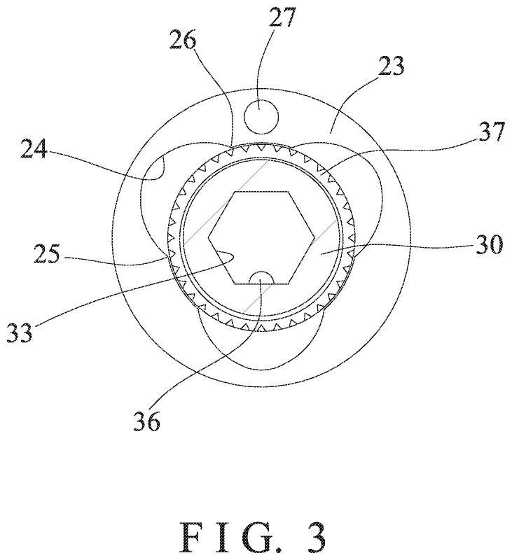

The insert 20 further includes an enlarged block or head 23 formed or provided thereon, and includes one or more (such as three) depressions or notches 24 formed in the head 23 or in the insert 20 and equally spaced from each other, and each notch 24 of the insert 20 is provided for forming or defining two pawls 25, 26, such as a first and a second pawls 25, 26, for selectively engaging with the ratchet teeth 37 of the shaft 30 and for determining the rotating or driving direction of the shaft 30 with or by the insert 20. The shaft 30 is made of relatively stronger materials, such as plastic, steel, iron, synthetic materials or the like. For example, as shown in FIG. 3, when the head 23 of the insert 20 is pivoted or rotated relative to the shaft 30 in one direction, such as clockwise, to force the first pawls 25 to engage with the teeth 37 of the shaft 30, the shaft 30 may be selectively rotated or driven by the handle 10 and the insert 20 clockwise.

On the contrary, when the head 23 of the insert 20 is pivoted or rotated relative to the shaft 30 in the other direction, such as counter clockwise, to force the second pawls 26 to engage with the teeth 37 of the shaft 30, the shaft 30 may be selectively rotated or driven by the handle 10 and the insert 20 counter clockwise. When the head 23 of the insert 20 is pivoted or rotated relative to the shaft 30 to disengage the pawls 25, 26 from the teeth 37 of the shaft 30, the shaft 30 may not be rotated or driven by the handle 10 and the insert 20. A rotary member or follower 40 includes a bore or space 41 formed therein for receiving or engaging with the shaft 30 for allowing the follower 40 to be pivotally or rotatably engaged onto the shaft 30. The follower 40 includes one or more (such as three) cavities or recesses 42, 43, 44 formed therein and faced or directed toward the head 23 of the insert 20.

The insert 20 further includes a spring biasing member or spring biased projection 27 engaged in the head 23 and faced or directed toward the follower 40 for engaging with either of the recesses 42, 43, 44 of the follower 40 selectively, and thus for determining the rotating or driving direction of the shaft 30 with or by the insert 20. For example, when the first pawls 25 are forced to engage with the teeth 37 of the shaft 30, the spring biased projection 27 may be engaged with one of the recesses 42 of the follower 40, and the spring biased projection 27 may be engaged with the other recess 43 of the follower 40 when the second pawls 26 are forced to engage with the teeth 37 of the shaft 30, and the spring biased projection 27 may be engaged with the further recess 44 of the follower 40 when the pawls 25, 26 are not engaged with the teeth 37 of the shaft 30.

As shown in FIGS. 2 and 4-5, a cylindrical member or sleeve 50 is pivotally or rotatably engaged onto the shaft 30 and contactable or engageable with the detent 36 (FIG. 2) for forcing the detent 36 to engage with the tool bit 8 selectively and for anchoring or retaining or positioning the tool bit 8 to the shaft 30 and for preventing the tool bit 8 from being disengaged or separated from the shaft 30 inadvertently. The sleeve 50 includes an inner peripheral groove 51 formed therein (FIG. 2) for receiving or engaging with the detent 36 selectively when the sleeve 50 is slid or moved relative to the shaft 30. A spring biasing member 52 may also be engaged onto the shaft 30 and contactable or engageable with or between the follower 40 and the sleeve 50 for biasing and forcing the sleeve 50 to move or slide relative to the shaft 30 and to disengage or separate the peripheral groove 51 of the sleeve 50 from the detent 36 selectively.

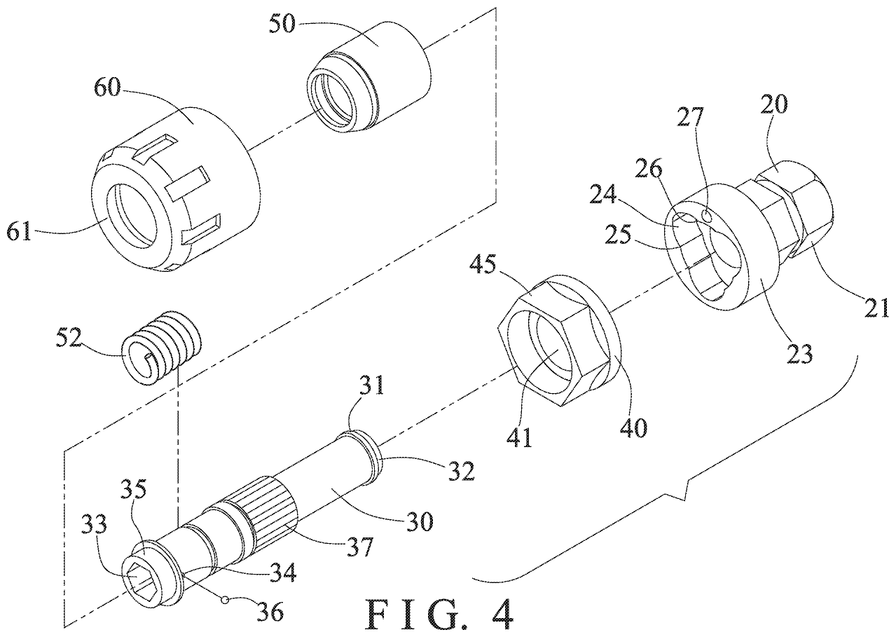

A control ferrule 60 is pivotally or rotatably engaged onto the shaft 30 and the sleeve 50, and the control ferrule 60 includes a peripheral flange 61 (FIGS. 2, 4) for contacting or engaging with the sleeve 50 and for forcing the sleeve 50 to move or slide relative to the shaft 30 and thus for aligning the peripheral groove 51 of the sleeve 50 with the detent 36 selectively and thus for allowing the detent 36 to be received or engaged into the peripheral groove 51 of the sleeve 50 selectively. When the control ferrule 60 is released, the spring biasing member 52 may bias and force the sleeve 50 to move relative to the shaft 30 and to disengage or separate the peripheral groove 51 of the sleeve 50 from the detent 36 again selectively or when required. When the detent 36 is received or engaged into the peripheral groove 51 of the sleeve 50, the tool bit 8 may be disengaged or separated or removed from the shaft 30 selectively or when required.

The control ferrule 60 includes a space 62 formed therein (FIG. 5) and having a non-circular cross section, such as a hexagonal cross section, for slidably receiving or engaging with a corresponding non-circular section or non-circular outer peripheral portion 45 of the follower 40, and for allowing the follower 40 to be pivoted or rotated relative to the shaft 30 and the insert 20, and also for allowing the control ferrule 60 to be moved or slid relative to the follower 40 when the control ferrule 60 force the sleeve 50 to move onto or against the spring biasing member 52. It is to be noted that the control ferrule 60 and the sleeve 50 may be slid or moved onto or against the spring biasing member 52 without moving or rotating the follower 40 relative to the shaft 30 and the insert 20.

In operation, as shown in FIG. 2, when the control ferrule 60 force the sleeve 50 to move onto or against the spring biasing member 52, the peripheral groove 51 of the sleeve 50 may be aligned with the detent 36 for allowing the detent 36 to be received or engaged into the peripheral groove 51 of the sleeve 50 selectively, and thus for allowing the tool bit 8 to be easily and quickly and readily disengaged or separated or removed from the shaft 30 selectively or when required. The head 23 of the insert 20 may be pivoted or rotated relative to the shaft 30 to force either the first or the second pawls 25, 26 to engage with the teeth 37 of the shaft 30 in order to determine the rotating or driving direction of the shaft 30 with or by the insert 20. It is further to be noted that the insert 20 and the follower 40 are received or engaged in the chamber 11 of the handle 10 such that the ratchet tool or ratchet screwdriver in accordance with the present invention includes a reduced structure or configuration for allowing the ratchet screwdriver to be easily and quickly and readily actuated or operated by the users or the like.

Many of the structures or configurations are described in their most basic form, but various parts or elements can be added to or deleted from any of the structures or configurations and information can be added or subtracted from any of the described messages without departing from the basic scope of the present invention. It will be apparent to those skilled in the art that many further modifications and adaptations can be made. The particular embodiments are not provided to limit the invention but to illustrate it.

The scope of the embodiments of the present invention is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A ratchet tool comprising:
a handle including a chamber formed in said handle,
an insert received and engaged in said handle and rotated in concert with said handle,
a shaft rotatably engaged through said insert, said shaft including a non-circular hole formed in said shaft for receiving and engaging with a tool bit and for allowing said tool bit to be rotated and driven by said shaft, said shaft including an aperture formed in said shaft and communicating with said hole of said shaft, said shaft including a plurality of teeth formed on an outer peripheral portion of said shaft,
a detent received and engaged in said aperture of said shaft and engageable into said hole of said shaft for engaging with said tool bit,
said insert including a head having a first pawl and a second pawl for engaging with said teeth of said shaft and for determining a driving direction of said shaft by said insert,
a sleeve rotatably engaged onto said shaft and engageable with said detent for forcing said detent to engage with said tool bit selectively, and said sleeve including an inner peripheral groove formed in said sleeve for receiving and engaging with said detent and for allowing said detent to be engaged into said peripheral groove of said sleeve and for allowing said tool bit to be disengaged from said shaft,
a spring biasing member engaged onto said shaft and engaged with said sleeve for biasing and forcing said sleeve to move relative to said shaft and to separate said peripheral groove of said sleeve from said detent, and
a control ferrule rotatably engaged onto said shaft and said sleeve and engaged with said sleeve and for forcing said sleeve to move relative to said shaft and for aligning said peripheral groove of said sleeve with said detent.

2. The ratchet tool of claim 1, wherein said control ferrule includes a peripheral flange engaged with said sleeve and for forcing said sleeve to move relative to said shaft.

3. The ratchet tool of claim 1, wherein said insert includes at least one notch formed in said head for forming said first pawl and said second pawl in said head.

4. The ratchet tool of claim 1, wherein a follower is rotatably engaged onto said shaft, said follower includes a space for engaging with said shaft and for allowing said follower to be rotatably engaged onto said shaft.

5. The ratchet tool of claim 4, wherein said follower includes a first recess and a second recess formed in said follower and directed toward said head of said insert, and said insert includes a spring biased projection engaged in said head and directed toward said follower for engaging with either said first or said second recess of said follower.

6. The ratchet tool of claim 4, wherein said follower includes a non-circular outer peripheral portion, said control ferrule includes a non-circular space formed in said control ferrule for slidably receiving and engaging with said non-circular outer peripheral portion of said follower and for allowing said follower to be rotated relative to said shaft and said insert with said control ferrule.
